(19) United States
(12) Patent Application Publication
(10) Pub. No.: US 2006/0040240 A1
(43) Pub. Date: Feb. 23, 2006

(54) Educational tool and method of use thereof

(76) Inventor: Alex Kopilevich, Woodland Hills, CA (US)

Correspondence Address: Marshall E. Rosenberg, Esq.;Registered Patent Attorney, P.O. Box 966, Woodland Hills, CA, 91365-0966, US

(21) Appl. No.: 10/919,189

(22) Filed: Aug. 16, 2004

(51) Int. Cl. G09B 21/00

(52) U.S. Cl. 434/112; 434/159

(57) ABSTRACT

An educational tool for use in connection with assisting educationally-challenged students, including autistic students, in developing higher skill sets is disclosed. According to the invention, the tool assists in teaching higher level skills sets including those necessary and desirable for promoting learning of borders and edges, as commonly found in a wide variety of diverse shapes, numbers, characters, and other anthropomorphic shapes, designs, and other indicia known and unknown, to teach boundaries, parameters and borders according to the educational protocol of the present invention. The invention is directed to a set of visual display of graphics incorporating a set of boundaries incorporated into the design of the characters to be learned, provided on a sheet that may be included in a collection and optionally separable from the collection as determined by the teacher. Whether provided in a bound volume or separable, each sheet has a surface with any of the characters that are the subject of the instant educational exercise.

### CROSS-REFERENCE TO RELATED APPLICATIONS

not applicable.

### STATEMENT RE: FEDERALLY SPONSORED RESEARCH/DEVELOPMENT

not applicable.

### BACKGROUND OF THE INVENTION

1. Field of the Invention

The present invention relates generally to educational tools and, more particularly, to an educational tool and method of use thereof for use in teaching higher skills sets to students with disabilities affecting learning processes.

2. Description of the Related Art

Educational teaching processes are implemented for students having a wide range and diversity of learning capabilities. One of such groups of students includes the autistic, which is a complex developmental disability that typically appears during the first three years of life. Autism is generally believed to be the result of a neurological disorder that affects the functioning of the brain, with a range of occurrences estimated at 2 to 6 per 1,000 births (Centers for Disease Control and Prevention, 2003). Assessment and testing programs have been developed to address the unique educational challenges of the autistic. One such test is known as “The Psychoeducational Profile Revised (PEP-R)”, by Eric Schopler, Eric, Robert Jay Reichler, Ann Bashford, Margaret D. Lansing, Lee M. Marcus. The Psychoeducational Profile Revised (PEP-R). Austin: Pro-Ed, 1990.

The PEP-R is an assessment and program planning tool for preschool and gradeschool-aged children with autism. The test covers a variety of key developmental areas and can help the give one a better picture of the, sometimes sporadic, developmental patterns of children with autism. The test items are presented with simple, concrete instructions, and most of the expected responses are nonverbal. Briefly, the PEP-R is an inventory of behaviors and skills designed to identify uneven and idiosyncratic learning patterns. According to the authors, the test is most appropriately used with children functioning at of below the preschool range and within the chronological age range of 6 months to 7 years. If a child is older than 7 but younger than 12 years, the PEP-R can provide useful information when at least some developmental skills are at or below the first-grade level. After 12 years of age, a prevocational evaluation using the Adolescent and Adults Psychoeducational Profile (AAPEP) (Mesihov, Schopler, Shaffer, & Landrus, 1988) is recommended.

In addition, when used as an assessment, the PEP-R provides information on developmental functioning in Imitation, Perception, Fine Motor, Gross Motor, Eye-Hand Integration, Cognitive Performance, and Cognitive Verbal areas. The PEP-R also identifies degrees of behavioral abnormality in Relating and Affect (cooperation and human interest), Play and Interest in Materials, Sensory Responses, and Language. As such, the PEP-R kit consists of a set of toys and learning materials that are presented to a child within structured play activities. The examiner observes, evaluates, and records the child's responses during the test. Then, at the end of the session, the child's scores are distributed among seven Developmental and four Behavioral areas. The resulting profiles depict a child's relative strengths and weaknesses in different areas of development and behavior.

Rather than evaluating a child using only Passing or Failing scores, the PEP-R provides a third and unique score called Emerging. A response scored “emerging” is one that indicates some knowledge of what is required to complete a task, but not the full understanding or skill necessary to do so successfully. A child may demonstrate a sense of what a task is about or even partially complete it, but do so in a peculiar way. These kinds of responses are scored as “emerging”.

Autism involves not only developmental delays but atypical behaviors. The strength of the PEP-R is that it looks at both of these aspects. The Developmental Scale tells where a child is functioning relative to peers. The items on the Behavioral Scale have the separate but related assessment function of identifying responses and behaviors consistent with a diagnosis of autism. These categories and measures are based on the Childhood Autism Rating Scale (CARS) (Schopler et al., 1988) designed to screen for and diagnose autism.

The total number of unusual, or dysfunctional behaviors are quantified qualified, indicating the severity of a child's behavioral difficulties. Behaviors are scored as Appropriate, Mild, or Severe. The items on the Behavioral Scale are not norm-referenced like those on the Developmental Scale; these particular behaviors, in their mild or extreme forms, are abnormal for children at any age. Scores from the Behavioral Scale can be useful for tracking behavioral changes over time and making decisions on how to group youngsters in a classroom.

In addition to its scoring system, the underlying use of the PEP-R is designed to differ from most psychological instruments, in which the PEP-R inventory system is designed as an educational tool for planning individualized special educational programs. There are three companion volumes to the PEP-R in the series called Individualized Assessment and Treatments for Autistic and Developmentally Disabled Children, Volumes 2 and 3, Teaching Strategies for Parents and Professionals (Schopler, Reichler, & Lansing, 1980) and Teaching Activities for Autistic Children (Schopler, Lansing, & Waters, 1983) are collections of individualized teaching activities, indexed according to the seven PEP-R developmental function areas. Volume 4, Adolescent and Adult Psychoeducational Profile (AAPEP) (Mesibov et al., 1988), extends the PEP-R to meet the needs of adolescents and adults.

Other educational systems are known. The Assessment of Basic Langauge and Learning Skills (or ABLLS, often pronounced “ables”) is acknowledged as a comprehensive, behavioral assessment tool based on Skinner's 1957 Analysis of Verbal Behavior. The ABLLS is utilized in cooperation with Sundberg and Partington's Teaching Language to Children with Autism or Other Developmental Disabilities, a guide to verbal-behavior based instruction. The assessment provides guidance in running, scoring, and interpreting the assessment, as well as in designing an intervention curriculum based on the results. The ABLLS assesses behaviors in 26 domains, including the following:
cooperation and reinforcer effectiveness
visual performance
receptive language
imitation
vocal imitation
requests
labeling
intraverbals
spontaneous vocalizations
syntax and grammar
play and leisure
social interaction
group instruction
following classroom routines
generalized responding
reading skills
math skills
writing skills
spelling
dressing skills
eating skills
grooming
toileting skills
gross motor skills, and
fine motor skills.

Yet additional testing and assessment protocols have been devised. Autism Screening Instrument for Educational Planning Second Edition (ASIEP-2) provides a comprehensive list of screening tools and sub-tests which all screen or evaluate autistic features in children and adults. This test scores on the following categories:
sensory
relating body and object use
language
social and self help
autism behavior
vocal behavior
repetitive
non-communicative
babbling
unintelligible
interaction
independent play
no response
negative
educational assessment
in seat
receptive language
expressive language
body concept
speech imitation
hand-shaping
random Position-A
fixed Position-B
fixed Position-C, and
random Position-D.

The ASIEF-2 test also includes five sub-tests, as follows:
autism behavior checklist
the sample of vocal behavior
the interaction assessment
the educational assessment, and
the prognosis of learning rate.

A further testing and assessment tool is the Behavior Rating Instrument for Autistic and other atypical children (BRIAC), for assessing the seven scales of development of autistic people of all ages. Those seven scales measure the following areas:
relationship to an adult
communication
drive for mastery
vocalization and expressive speech
sound and sound reception
social responsiveness, and
psycho-biological development

In addition, two further scales are employed to assess non-vocal communication for children who use manual communication due to vocal and/or hearing deficits.

In an effort to address the non-vocal communications-related protocols, there is known the field of devices primarily designed to assist the blind or nearly blind in learning braille by speaking, sounding, or displaying in enlarged form a letter, number, word, phrase, or musical note corresponding to a pattern of braille dots embossed upon a tactile flash card. Braille is a tactile system using raised dots to represent the letters of the alphabet, numerals, punctuation marks, or musical notes for persons with severe visual impairment. Each letter of the alphabet, numeral, punctuation mark, or musical note is formed from raised dots arranged within a cell (a “braille cell”) having three rows and two columns. Braille is read by moving the fingers gently over the surface which has been embossed with the braille dots. However, the use of braille for testing and assessment of the autistic or otherwise learning challenged student is not known.

However, what is known in the related art are numerous educational toys for teaching children letters and numbers. For example, U.S. Pat. No. 4,968,255 to Lee et al. discloses an electronic interactive speech producing apparatus for instructing children in letters and numbers. The apparatus, constructed in the form of a school bus, has a plurality of input sockets arranged at each window position of the school bus and answer blocks having complementary input detection elements for engagement with the input sockets. Each answer block has a display face with an embossed number or a letter formed thereon. Insertion of the answer blocks triggers an audible presentation of the letter or number displayed thereon. U.S. Pat. No.
3,845,958 to Reinertsen discloses another toy for teaching children letters and numbers. The toy has a tray and a plurality of disks. Each disk has an aperture patterned as a letter or number and the tray has a plurality of complementarily-shaped protrusions for cooperation with the apertures in the disks.

However, none of these assessment and testing programs considers the use of certain feedback mechanisms that are the subject matter of the present invention, those feedback mechanisms believed to assist the student in developing higher skill sets, especially for autistic students.

Therefore, it is desirable to provide an educational tool and method of use thereof for use in connection with assisting an educationally-challenged student in developing higher skill sets, and especially for autistic students.

### OBJECTS AND SUMMARY OF THE INVENTION

It is therefor an object of the present invention to provide an educational tool for use in connection with assisting an educationally-challenged student in developing higher skill sets, and especially for autistic students.

It is another object of the present invention to provide a method of use for an educational tool for assisting autistic students in developing higher skill sets.

The present invention is directed to an educational tool for use in connection with assisting educationally-challenged students, including autistic students, in developing higher skill sets. According to the invention, the inventive educational tool assists in teaching higher level skills sets including those necessary and desirable for promoting learning of borders and edges, as commonly found in a wide variety of diverse shapes, numbers, characters, and other anthropomorphic shapes, designs, and other indicia known and unknown, thereby teaching boundaries, parameters and borders according to the educational protocol of the present invention. Specifically, the present invention is directed to a set of visual display of graphics incorporating a set of boundaries incorporated into the design of the characters to be learned, provided on a sheet that may be included in a collection and optionally separable from the collection as determined by the teacher. Whether provided in a bound volume or separable, each sheet has a surface with any of the characters that are the subject of the instant educational exercise. It will be appreciated that according to the invention, there is provided a volume of such related pages, each optionally corresponding to a unique educational lesson.

According to the invention, each sheet/page on which one or more characters is provided includes for each character a shape that includes certain characteristic information. That information includes shape information, textural information, and color information. Each character may include a single or multiple pieces of information incorporated therein. For example, a shape information must necessarily include at least textual information or color information, or both in integrated form. Textual information may include raised aspects of the shape provided on the page, those raised aspects having variable height according to the teaching lesson. Textual information may also include tactile information, including flexible/rigid characteristics, bumpy/smooth characteristics, ridged/valleyed characteristics, and optionally color characteristics as previously noted. Color information may include solid color information on all or part of each aspect of the shape information, as well as color combinations and patterns. In turn, pattern information may be single-toned over a common background, or multi-colored, all of which is intended in achieving the objectives of the present invention. Thus, each design page includes at least one design, and multiple pages may be fashioned into chapters consistent with a teaching plan designed to teach and reinforce the boundary-educational lessons as will be appreciated by the educational professional. Accordingly, each page has at least one design provided upon its front surface, that design having textural, shape, or color information designed to teach and reinforce in the mind of the student boundary and other lessons incorporated therein.

According to the various additional preferred embodiments of the invention, various chapters and volumes incorporating related and unrelated graphics, including shapes, numbers, letters, characters, anthropomorphic shapes and characters, incorporating various tactual attributes contribute to this new educational tool. The method of use of the educational tool of the present invention includes the systematic introduction of related and unrelated graphics to the student, further extending from the simple to the complex shape, with reinforcement offered in terms of various tactual attributes including the use of the aforementioned colors and patterns, with or without textured attributes.

It should be noted and understood that with respect to the embodiments of the present invention disclosed herein, the materials, methods, apparatus and processes disclosed and suggested may be modified or substituted to achieve the desired protected structures without departing from the scope and spirit of the disclosed and claimed invention.

### BRIEF DESCRIPTION OF THE DRAWINGS

FIG. 1 is a plan view of one sample graphic shape utilized in the educational tool of the present invention, showing one preferred embodiment in the shape of a star.

FIG. 2 is a side elevational view taken along line 2-2 of FIG. 1, showing a raised attribute comprising one of a selected tactual features of a preferred embodiment of the grid board of the card reader of FIG. 1.

FIG. 3 is a chart showing additional graphic shapes, according to the preferred embodiment of the invention, including another star shape, two rectilinear shapes including a square and a rectangle, a circle shape, and a triangle shape.

FIG. 4 is a chart showing additional graphic shapes, according to the preferred embodiment of the invention, including the numbers 0-9.

FIG. 5 is a chart showing additional graphic shapes, according to the preferred embodiment of the invention, including the letters a through z of the arabic alphabet.

FIG. 6 is a chart showing additional graphic shapes, according to the preferred embodiment of the invention, including anthropomorphic characters including male and female children

FIG. 7 is a chart showing additional graphic shapes, according to the preferred embodiment of the invention, including two domestic animals including a cat and a dog.

FIG. 8 is a chart showing additional graphic shapes, according to the preferred embodiment of the invention, including several additional animals including a horse, a cow, a duck, and a lamb.

### DETAILED DESCRIPTION OF THE INVENTION

The detailed description as set forth below in connection with the appended drawings is intended as a description of the presently preferred embodiments of the present invention, and is not intended to represent the only form(s) in which the present invention may be constructed or utilized. The description sets forth functions and sequence of steps for constructing and operating the invention in connection with the illustrated embodiments. It is understood, however, the same or equivalent functions and sequences may be accomplished by different embodiments and that they are also intended to be encompassed within the spirit and scope of this invention.

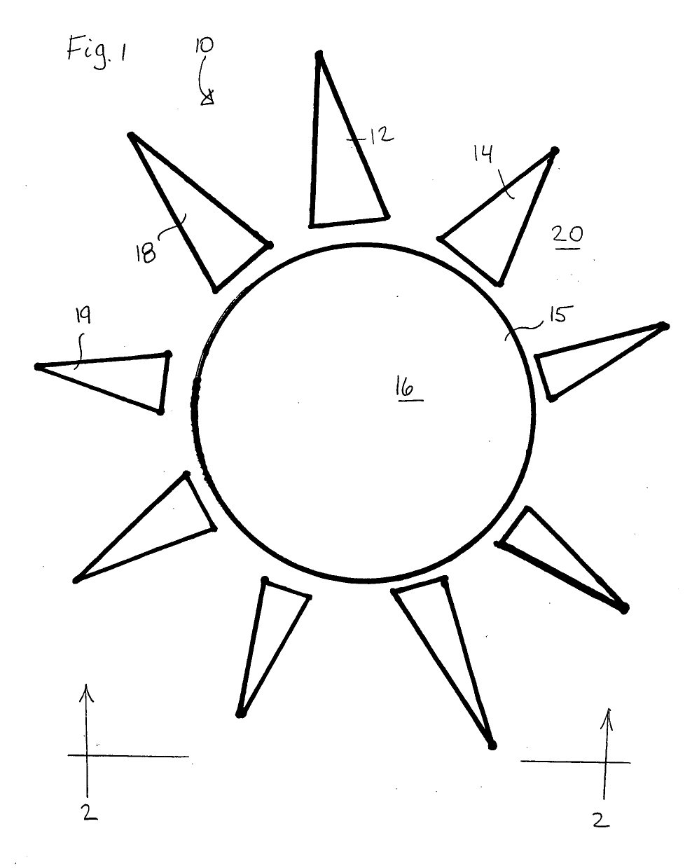

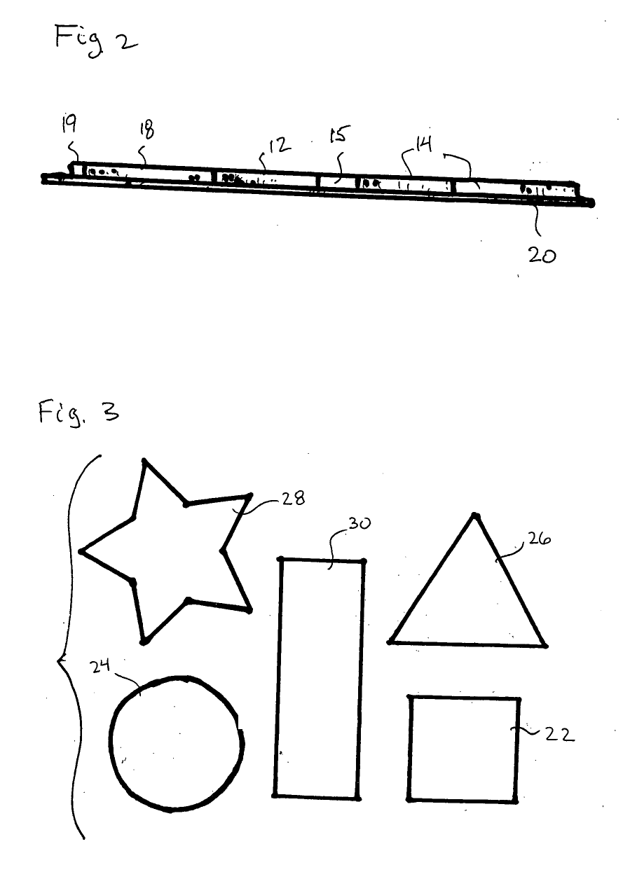

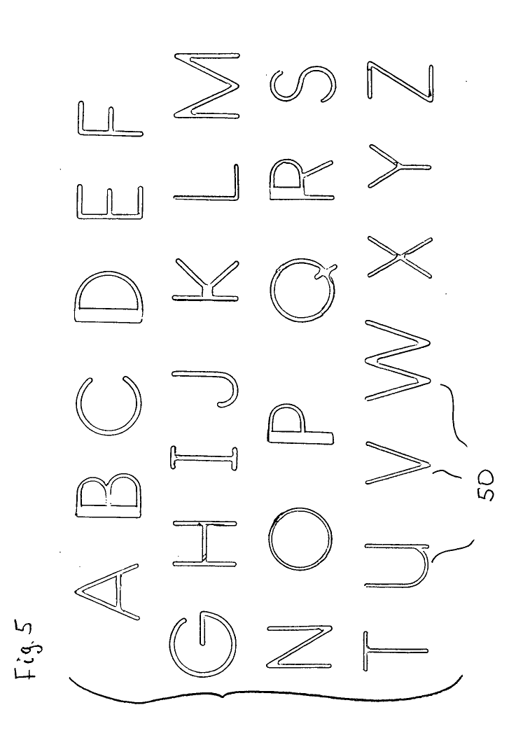

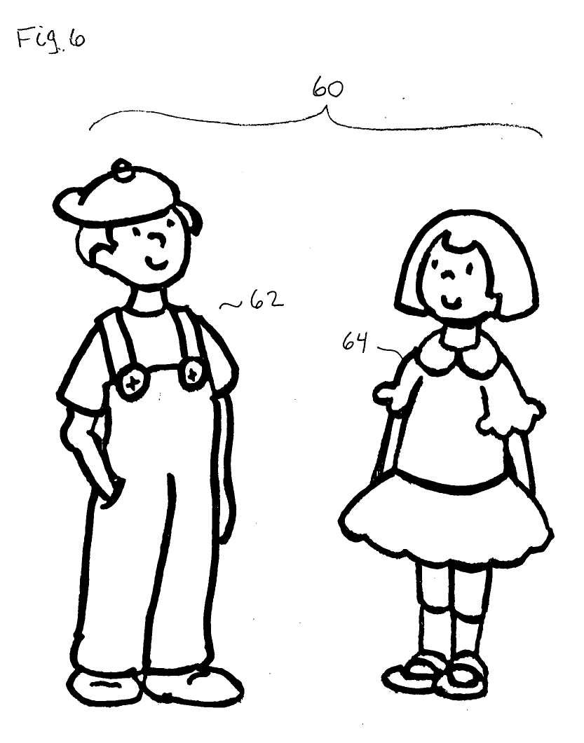

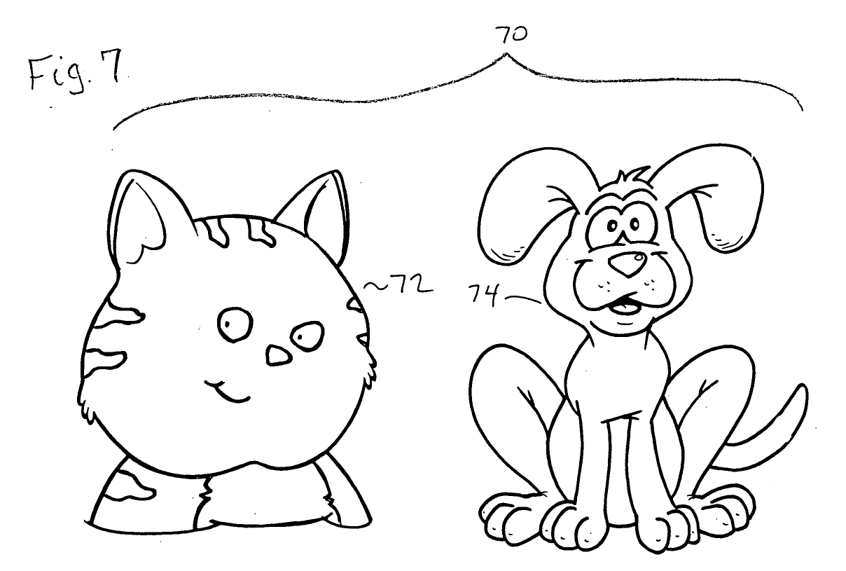

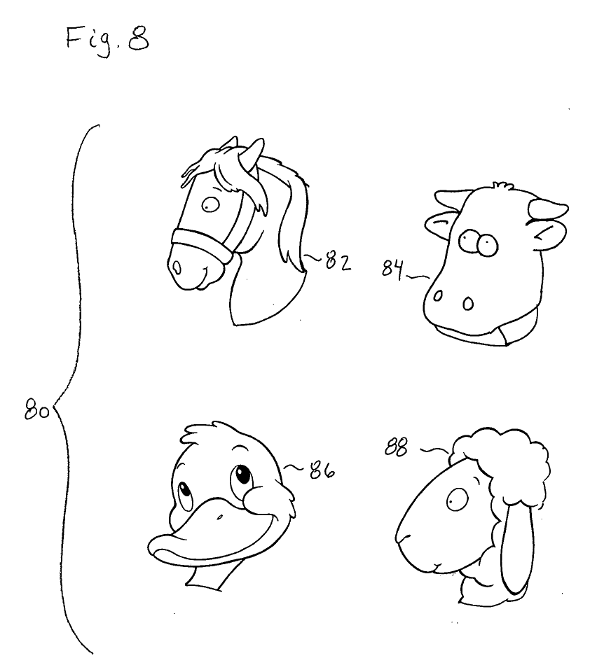

With reference now to the drawing figures, FIGS. 1-3 represent a first preferred embodiment of the present invention, directed to an educational tool 10 for use in connection with assisting educationally-challenged students, including autistic students, in developing higher skill sets. According to the invention, the inventive educational tool 10 includes at least one sheet or card 20 on which a selected graphic is provided. Such graphics may be selected from the group of designs such as that shown in FIGS. 1-3, numbers such as those shown in FIG. 4, letters such as those shown in FIG. 5, anthropomorphic designs such as those shown in FIG. 6, and/or animal-related designs such as those shown in FIGS. 7 and 8, as will be more fully described below. For a raised graphic, offset printing or other types of printing may be utilized to achieve the objectives of the present invention. Other methods such as those known in the printing and publishing arts may be utilized to create the desired raised outlines having a desired height, thickness, texture, resiliency and color(s), to provide the educational attributes germane to the present invention, and it will be appreciated by the skilled artisan that combinations of these and other related attributes may be employed in this respect. Thus, for a selected graphic as shown in various exemplary manners in the various FIGS. 1-8, those shapes are thus imprinted on a selected sheet or card 20, in whole or in part. By way of example, the sunburst provided as graphic 10 includes point sections 12, 14, 18, 19 extending radially outwardly from center section 16. It will be appreciated that any one or selected ones of point sections 12, 14, 18, 19, 16 may be provided with perimeters or entire sections having tactile heights that are of even height, such as that height shown in FIG. 2, and it will be appreciated that any or all of those sections of a graphic used in connection with the educational tool of the present invention may have differing heights as necessary and desired to provide enhanced educational features. Furthermore, center sections of selected ones of the point sections 12, 14, 18, 19, or of the center section 16 may be raised or depressed to further assist the student in ascertaining the limitations of the perimeters of the various sections or even of the entirety of the graphic 11.

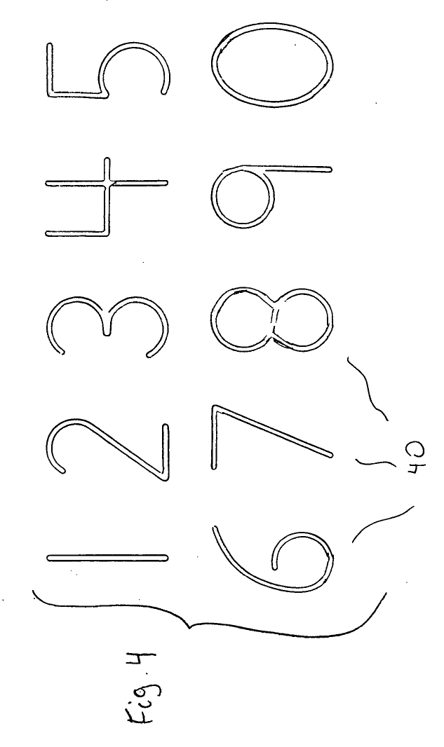

With attention now directed to FIG. 3, there is shown therein a variety of additional shapes, numbers, and graphics. Again by way of example, outer perimeters of the square 22, circle 24, triangle 26, unitary star 28, and rectangle 30 may have raised or depressed center sections, to provide tactile information to the student in assessing the limits of the boundaries of each of said shapes 22, 24, 26, 28, 30. It will be appreciated that one or a combination of any of the shapes may be provided on the same, following or other sheets or cards 20, either as previously assigned or determined by the teacher to assist in teaching higher level skills sets including those necessary and desirable for promoting learning of borders and edges, as commonly found in a wide variety of diverse shapes, numbers, characters, and other anthropomorphic shapes, designs, and other indicia known and unknown, thereby teaching boundaries, parameters and borders according to the educational protocol of the present invention, and advancing the state of the art as previously described.

With reference now to FIG. 4, a set of numbers 40 incorporating the boundary concept of the present invention is shown therein. Each member of the number set includes an outer boundary with partial or complete raised boundary perimeters. It is contemplated that number systems other than that system shown herein may be suitable subject matter for educational purposes across a diverse population base knowledgeable in such other number systems.

With reference now to FIG. 5, a set of letters 50 incorporating the boundary concept of the present invention is shown therein. Each member of the letter set includes an outer boundary with partial or complete raised boundary perimeters. It is contemplated that alphabet/lettering systems other than that system shown herein may be suitable subject matter for educational purposes across a diverse population base knowledgeable in such other number systems.

With reference now to FIG. 6, a set of anthropomorphic shapes 60, such as a generic male shape 62 and a generic female shape 64 also incorporates the boundary concept of the present invention. Each shape 62, 64 includes an outer boundary with partial or complete raised boundary perimeters over part or all of the shape as necessary and desired. It is contemplated that other anthropomorphic shapes are amenable to meeting the educational objectives of the present invention, including but not limited to infantile, juvenile, and adult forms of the anthropomorphic shapes, provided in any of a variety of assumed positions, and with or without additional embellishments including but not limited to apparel, sporting gear, assistive/adaptive equipment and the like, with all of such depictions incorporating the selective raised boundary technology of the present invention.

With reference now to FIGS. 7-8, a set of animal shapes 70 are contemplated for use in connection with the present invention, including but not limited to domestic animals such as a cat 72, dog 74, horse 82, cow 84, duck 86 and sheep 88, all of which incorporates the boundary concept of the present invention. Other animal shapes are contemplated including shapes depicting wild animals including but not limited to wild creatures found on land, in the air and in the sea, such as lions, tigers, elephants, birds, sharks, octopus and so on, each shape of which is printed with an outer boundary having partial or complete raised boundary perimeters over part or all of the shape as necessary and desired.

Thus, the present invention is directed to a set of visual display of graphics incorporating a set of boundaries incorporated into the design of the characters to be learned, provided on one or more sheets or cards 20 that may be included in a collection and optionally separable from the collection as determined by the teacher. Whether provided in a bound volume or separable, each sheet or card 20 has a surface with any of the characters that are the subject of the instant educational exercise. It will be appreciated that according to the invention, there is provided a volume of such related pages, each optionally corresponding to a unique educational lesson.

Furthermore, and according to the invention, each sheet or card 20 on which one or more characters is provided includes for each character a shape that includes certain characteristic information. That information includes shape information, textural information, and color information. Each character may include a single or multiple pieces of information incorporated therein. For example, a shape information must necessarily include at least textual information or color information, or both in integrated form. Textual information may include raised aspects of the shape provided on the page, those raised aspects having variable height according to the teaching lesson. Textual information may also include tactile information, including flexible/rigid characteristics, bumpy/smooth characteristics, ridged/valleyed characteristics, and optionally color characteristics as previously noted. Color information may include solid color information on all or part of each aspect of the shape information, as well as color combinations and patterns. In turn, pattern information may be single-toned over a common background, or multi-colored, all of which is intended in achieving the objectives of the present invention. Thus, each design page includes at least one design, and multiple pages may be fashioned into chapters consistent with a teaching plan designed to teach and reinforce the boundary-educational lessons as will be appreciated by the educational professional. Accordingly, each page has at least one design provided upon its front surface, that design having textural, shape, or color information designed to teach and reinforce in the mind of the student boundary and other lessons incorporated therein.

According to the various additional preferred embodiments of the invention, various chapters and volumes incorporating related and unrelated graphics, including shapes, numbers, letters, characters, anthropomorphic shapes and characters, incorporating various tactual attributes contribute to this new educational tool. The method of use of the educational tool of the present invention includes the systematic introduction of related and unrelated graphics to the student, further extending from the simple to the complex shape, with reinforcement offered in terms of various tactual attributes including the use of the aforementioned colors and patterns, with or without textured attributes.

It is to be understood that the present invention is not limited to the embodiments described above, but encompasses any and all embodiments within the spirit and scope of the following claims.

I claim:

1. An educational tool, comprising:
a sheet for displaying a symbol displayed on one side thereof; and
the symbol having tactile attributes for teaching a boundary concept to a student.

2. The educational tool recited in claim 1, wherein the symbol is selected from the group including textures, shapes and colors.

3. The educational tool recited in claim 1, wherein the symbol has an outer perimeter at least partially defining a shape, at least a section of the perimeter having a height.

4. The educational tool recited in claim 3, wherein the height is selectively variable about the entirety of the perimeter.

5. The educational tool recited in claim 1, wherein the sheet is selected from a collection having a set of related symbols.

6. The educational tool recited in claim 5, wherein the set of related symbols is selected from the group comprising graphic shapes, numbers, letters, anthropomorphic shapes, and animal shapes.

7. The educational tool recited in claim 1, further comprising a workbook including a set of sheets selected from a group of related symbols.

8. The educational tool recited in claim 1, further comprising a workbook including a plurality of sets of sheets each set comprising related symbols unrelated to symbols provided in other sets of sheets in the workbook.

9. The educational tool recited in claim 1, further comprising a collection of said sheets having a selection of symbols.

10. The educational tool recited in claim 9, wherein the workbook is a coloring book.

11. A method of instructing a student by performing an educational exercise,
including providing a first sheet displaying a symbol provided on one side thereof, the symbol having tactile attributes, and
instructing the student to identity attributes of the symbol based on tactile interpretation of boundaries of the displayed symbol.

12. The method of instructing a student as recited in claim 10, further providing feedback analysis to the student.

13. The method of instructing a student as recited in claim 10, further instructing the student to identify plural symbols.

14. The method of instructing a student as recited in claim 12, further assessing the student's feedback.

15. An apparatus for promoting boundary recognition, said apparatus being in the form of a sheet, the sheet having graphic display surface which bears indicia said indicia being comprised of at least a first included symbol including a raised perimeter portion.

16. The apparatus as recited in claim 14, wherein the symbol is selected from the group comprising graphic shapes, numbers, letters, anthropomorphic shapes, and animal shapes.

17. The apparatus as recited in claim 14, further comprising a workbook having a plurality of sheets stacked one upon another and removably bound together.

18. The apparatus as recited in claim 17, wherein the workbook is a coloring book.

19. The apparatus as recited in claim 14, wherein the workbook includes a set of sheets selected from a group of related symbols.

20. The apparatus as recited in claim 14, wherein the workbook includes a plurality of sets of sheets each set comprising related symbols unrelated to symbols provided in other sets of sheets in the workbook.
